(19) United States
(12) Patent Application Publication
(10) Pub. No.: US 2004/0168719 A1
(43) Pub. Date: Sep. 2, 2004

(54) System for dividing gas flow

(76) Inventor: Masahiro Nambu, Saitama (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/609,265

(22) Filed: Jun. 27, 2003

(30) Foreign Application Priority Data
Feb. 28, 2003 (JP) 53130/2003

(51) Int. Cl. G05D 11/00

(52) U.S. Cl. 137/87.04

(57) ABSTRACT

A system for dividing flow of gas into a plurality of secondary flow paths at predetermined ratios comprises pressure sensing type mass flow controllers in each secondary flow path and a common controller connected to the mass flow controllers. One of the secondary flow paths is fully opened, and the ratio of the flow rate in each of the other secondary flow paths relative to the flow rate in the fully opened path is set at a value of 1 or less. The common controller provides a set signal for each of the other mass flow controllers by multiplying a measured flow rate in the fully opened secondary flow path by a predetermined ratio. A wider range of divided flow ratios can be achieved and the response and flow accuracy are superior, especially when flow ratios are changed.

### FIELD OF THE INVENTION

This invention relates to the supplying of gas in apparatus such as a semiconductor manufacturing apparatus, and more particularly to a system for dividing gas flow so that the gas is supplied to a plurality of chambers at fixed ratios.

### BACKGROUND OF THE INVENTION

In semiconductor manufacture, where a semiconductor material is subjected to processes such as polishing, cleaning, oxidizing masking, and etching, in some cases several kinds of gases need to be mixed and supplied to a plurality of processing chambers at fixed ratios.

A conventional system 10A for dividing gas flow is shown in FIG. 10. In this system, gas is stored in gas cylinders 104a, 104b, 104c, and 104d, mixed in a gas box 110, and divided and supplied into process chambers 106 and 108 in a manufacturing apparatus.

Secondary flow paths 130 and 132 are connected to the processing chambers 106 and 108 respectively, and flow control devices 134 are provided in the secondary flow paths so that mixed gases supplied from the gas box 110 are divided into the secondary flow paths 130 and 132 at fixed ratios. However, this system for dividing flow is pressure-dependent. The gas pressure at the upstream of the secondary flow paths needs to be relatively high. If the pressure at the upstream side is low, gas may not be supplied accurately to the processing chambers.

To address the problem of pressure dependency, another flow-dividing system 10B, as shown in FIG. 11, has been used. In this system, the flow rate in one secondary flow path 114 is measured, and the flow rate in the other secondary flow path 116 is controlled, based on the flow rate in path 114, by a mass flow controller. The system of FIG. 11 is described in detail in U.S. Pat. No. 6,418,954, granted on Jul. 16, 2002, and the disclosure of is incorporate by reference. In this system, an output signal proportional to the mass flow in path 114, as measured by mass flow meter 118, is supplied as a control input signal to mass flow controller 122. Accordingly, the flow is divided equally, or at a fixed ratio, and the flow of gas in the secondary flow paths can be accurately controlled without the need to maintain a high pressure at the upstream side of the controller 122 and mass flow meter 118.

Since the system for dividing flow described in U.S. Pat. No. 6,418,954 controls a mass flow controller based on a flow rate output signal from a mass flow meter, the range of flow rates in the divided flow paths is narrow, and the flow rate in the mass flow controller cannot be larger than the flow rate in the mass flow meter. In addition, since this system for dividing flow uses a thermal-type mass flow meter and mass flow controller, the response is poor when the ratio of divided flow is changed. Moreover, where gases having greatly differing characteristics are to be controlled, the proper ratios of divided flow, and flow rate accuracy, may be difficult to obtain for all of the gases.

### SUMMARY OF THE INVENTION

In the system for dividing gas flow according to the invention, a gas in a primary flow path is divided into a plurality of secondary flow paths. The flow rate of gas in each of the secondary flow paths is related to the flow rate in each other one of the secondary flow paths by a predetermined ratio. The system comprises a plurality of mass flow controllers, there being one of mass flow controller arranged to control flow in each the secondary flow paths. A common controller is connected to all of the mass flow controllers. One of said secondary flow paths is fully opened, and the ratio of the flow rate of each other one of the secondary flow paths relative to the flow rate in the fully opened secondary flow path is set at a value of 1 or less, and the common controller delivers to the mass flow controller in each other one of the secondary flow paths, a set signal for controlling the flow therein, said set signal being obtained by multiplying the measured flow rate in the fully opened secondary flow path by the predetermined ratio for said one of the secondary flow paths. Each mass flow controller is preferably a pressure sensing type mass flow controller.

With this invention, since the mass flow controllers in the secondary flow paths are controlled by a common controller, the ranges of divided flows may be widened. In addition, the response at the time when dividing flow ratios are changed, and flow rate accuracy for gases of greatly different characteristics, may be improved by using a pressure sensing type mass flow controller.

### BRIEF DESCRIPTION OF THE DRAWINGS

FIG. 1 is a schematic diagram of a system for dividing flow according to the invention, wherein gas is divided into two flow paths;

FIG. 2 is a block diagram illustrating the manner in which control of the mass flow controllers is carried out in the system of FIG. 1;

FIG. 3 is a chart illustrating the operation of the system of FIG. 1;

FIG. 4 is a schematic diagram of a system for dividing flow according to the invention, wherein gas is divided into three flow paths;

FIG. 5 is a block diagram illustrating the manner in which control of the mass flow controllers is carried out in the system of FIG. 4;

FIG. 6 is a chart illustrating the operation of the system of FIG. 4;

FIG. 7 is a diagram showing a typical response of a system according to the invention using a pressure sensing type mass flow controller;

FIG. 8 is a diagram showing a typical response of a system according to the invention using a thermal-type mass flow meter and mass flow controller;

FIG. 9 is a characteristics diagram showing the relation between flow rates and output of a thermal-type mass flow meter;

FIG. 10 is a schematic view of a conventional system for dividing gas flow;

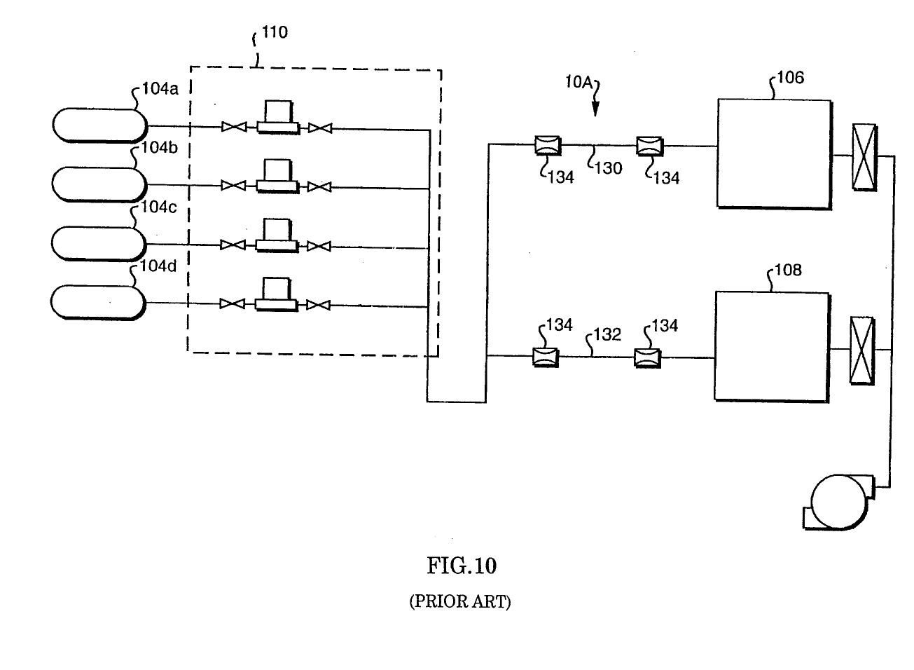

FIG. 11 is a schematic view of another conventional system for dividing gas flow; and

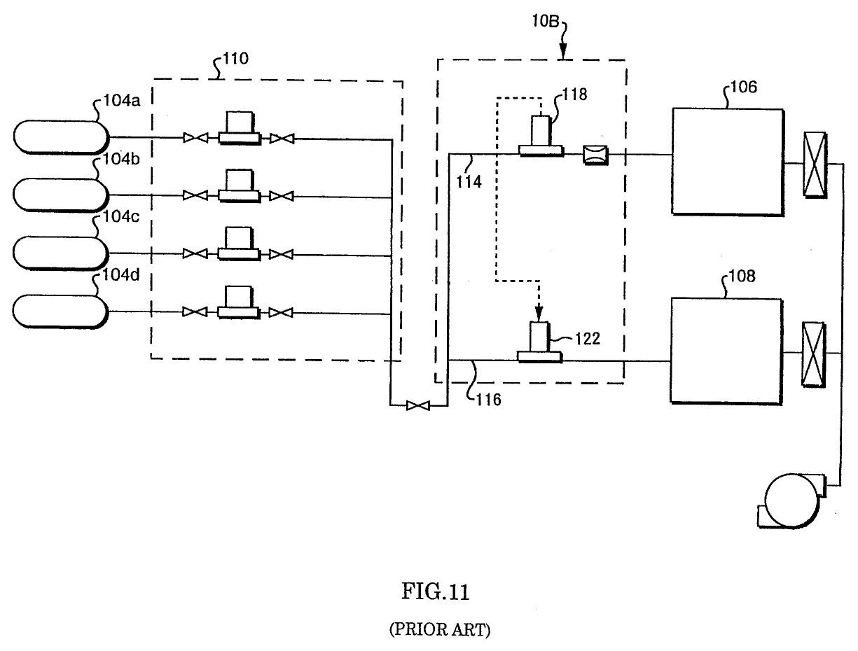

FIG. 12 is a schematic diagram of a system for dividing flow according to the invention, wherein gas is divided into two flow paths, both leading to a single processing chamber.

### DETAILED DESCRIPTION OF THE PREFERRED EMBODIMENTS

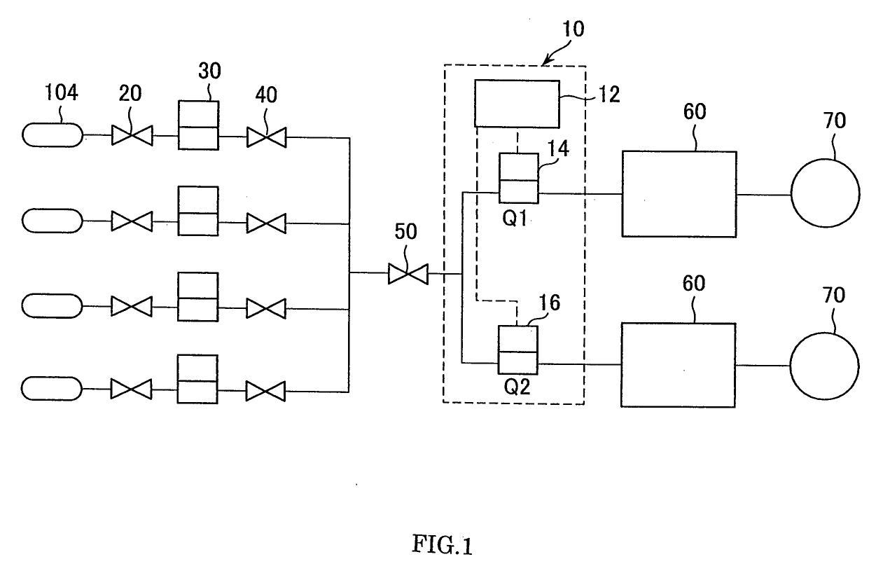

In FIG. 1, gases supplied from gas cylinders 104 pass through valves 20, which are open and shut type valves, and are controlled by mass flow controllers 30 so that their flow rate are fixed. The gases pass through open and shut valves 40 and 50, and into a system 10 for dividing flow wherein the gas passing through valve 50 is divided into secondary flow paths Q1 and Q2, and supplied to process chambers 60. The mass flow controllers include mass flow sensors, and are therefore capable sensing as well as controlling mass flow rate.

The flow dividing system 10 comprises mass flow controllers 14 and 16 in secondary flow paths Q1 and Q2 respectively, and a common controller 12 connected to the mass flow controllers 14 and 16. Predetermined flow ratios for paths Q1 and Q2 are set in the common controller 12. The common controller 12 controls the mass flow controllers 14 and 16 based on the predetermined flow ratios, and on a flow rate which is measured in one of the secondary flow paths Q1 and Q2.

The flow ratio is the ratio of two numbers, one number being 1, corresponding to a full-open flow rate in one of the secondary flow paths Q1 and Q2, and the other number being 1 or less, corresponding to the flow rate in the other secondary flow path. The common controller 12 produces an output signal obtained by multiplying the flow rate measured by the mass flow controller in the fully opened secondary flow path by the predetermined flow ratio, and the output signal is used as a set signal for the other mass flow controller. Mass flow controllers 14 and 16 are preferably pressure sensing type mass flow controllers, because pressure sensing controllers have a superior response.

During operation, gas is sent from the gas cylinders 104 to the process chambers 60 by vacuum pumps 70 which are connected to the process chambers 60. Various kinds of gases (four kinds in FIG. 1) may be supplied into the dividing system by selecting the gas cylinders 104 and the mass flow controllers 30.

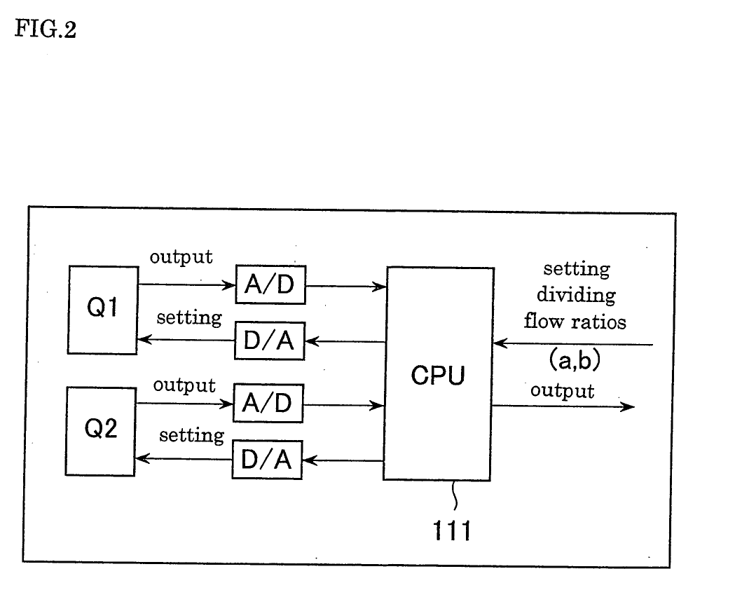

As shown in FIG. 2, while flow is taking place in the secondary flow paths, the outputs from the mass flow sensors in the secondary flow paths Q1 and Q2 are converted from analog to digital form for delivery to a digital central processing unit (CPU) 111. Outputs from the CPU 111 are converted from digital to analog form for delivery to the mass flow controllers in the secondary flow paths Q1 and Q2.

In FIGS. 1-3, the dividing flow ratios a, b are both less than or equal to 1, and the maximum value of each of a and b is 1. That is, a, b<=1, and Max(a, b)=1.

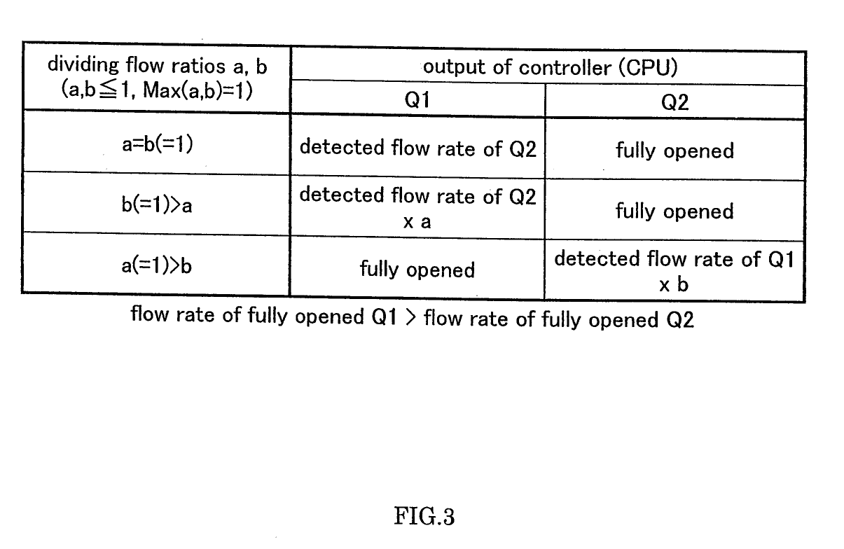

More specifically, the value of a or b is 1, corresponding to a full-open flow rate in one of the secondary flow paths Q1 and Q2, and the value of the other of a and b is 1 or less, corresponding to a set flow rate of the other secondary flow path. Set signals produced by the CPU are converted to analog form and delivered to the mass flow controllers as shown in FIG. 3. In the case where a is equal to 1 and a is greater than b, that is, when a(=1)>b, the secondary flow path Q1 is fully opened, a value corresponding to the flow rate detected in secondary flow path Q1 is multiplied by b, and the product is delivered as a set signal for the secondary flow path Q2. In the case where b is equal to 1 and b is greater than a, that is, when b(=1)>a, the secondary flow path Q2 is fully opened, a value corresponding to the flow rate detected in secondary flow path Q2 is multiplied by a, and the product is delivered as a set signal for the secondary flow path Q1. In addition, in the case where a and b are equal, that is when a=b(=1), a full-open flow rate of the secondary flow path Q1 is made larger than a full-open flow rate of the secondary flow path Q2, the secondary flow path Q2 is fully opened, and a value corresponding to the detected flow rate in the secondary flow path Q2 is given as a set signal for the secondary flow path Q1.

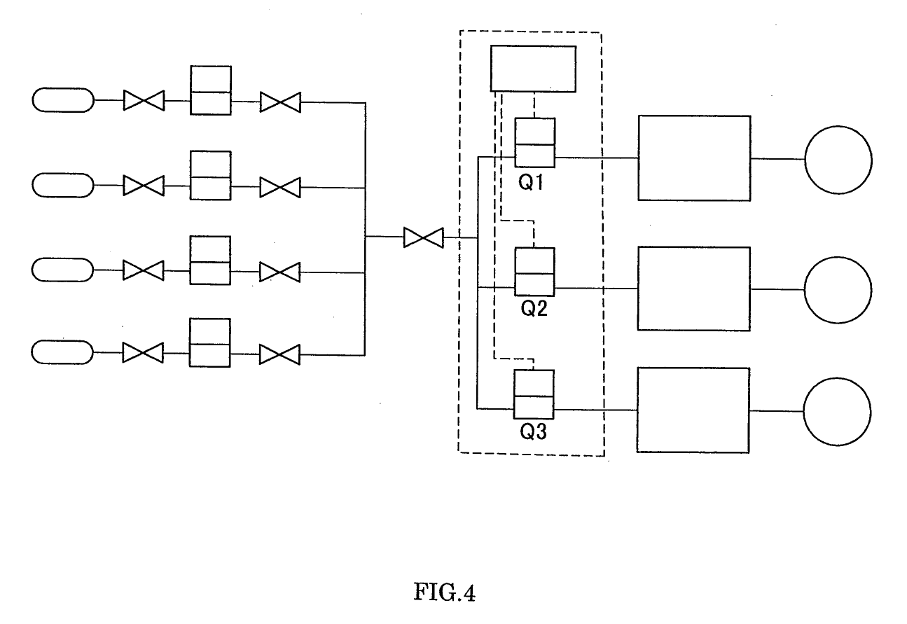

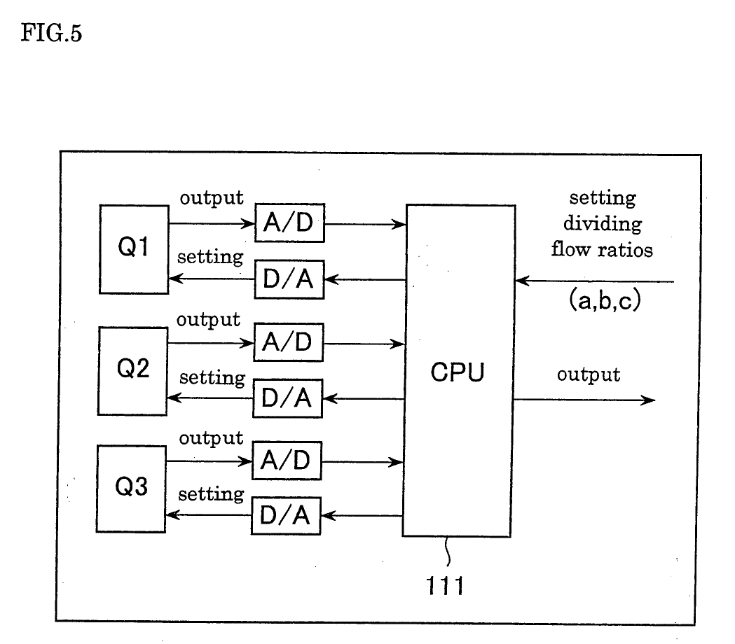

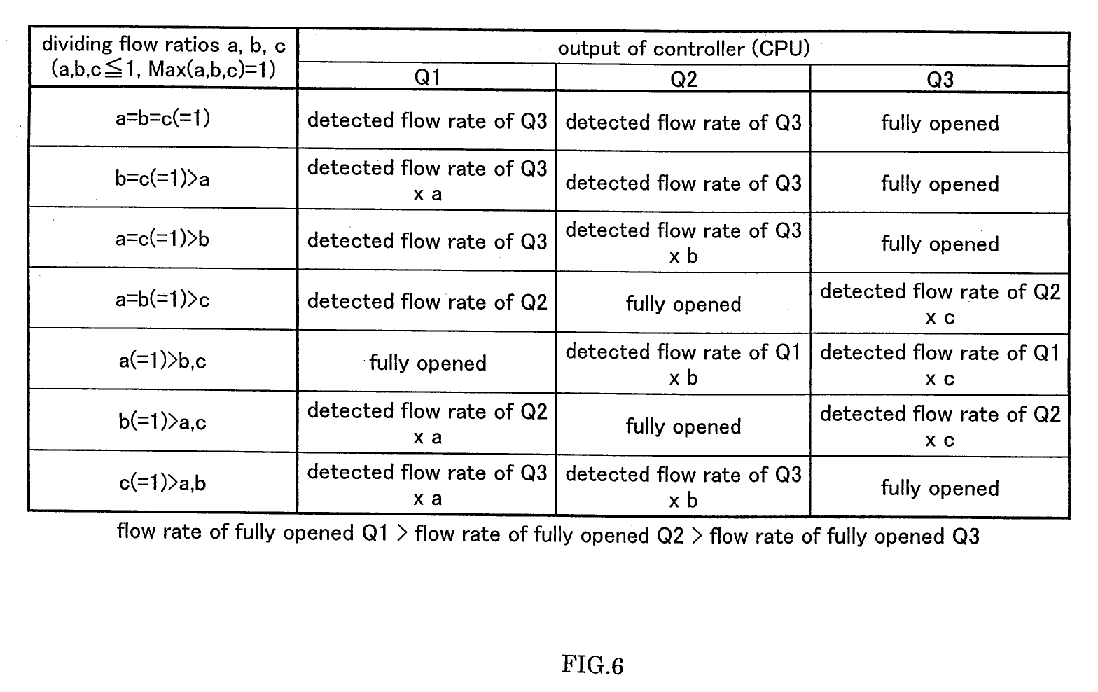

In FIGS. 4, 5 and 6, where gas is divided into three flow paths, the values of the dividing flow ratios a, b and c are all less than or equal to 1, and each has a maximum value of 1. That is, a, b, c<=1, and Max(a, b, c)=1. The value of 1 corresponds to the full-open flow rate in one of secondary flow paths Q1, Q2, and Q3, and the values of 1 or less corresponds to set flow rates in the other secondary flow paths. These values are set in the common controller, and set signals from the common controller are converted to analog form and delivered to mass flow controllers according to the command scheme shown in FIG. 6. A prerequisite is that the full-open flow rate of secondary flow path Q1 must be greater than the full-open flow rate of secondary flow path Q2, which, in turn must be greater than the full-open flow rate of a secondary flow path Q3.

In the case where a(=1)>b, c, the secondary flow path Q1 is fully opened, a signal which corresponds to the detected flow rate in path Q1 is multiplied by the ratio b, and the product is provided as a set signal for the secondary flow path Q2. The signal which corresponds to the detected flow rate in path Q1 is also multiplied by the ratio c, and the product is provided as a set signal for the secondary flow path Q3.

As will be apparent from FIG. 6, in the case where b(=1)>a, c and in the case of c(=1)>a, b, the processes are essentially the same as in the case where a(=1)>b, c.

In the case of a=b(=1)>c, the secondary flow path Q2, has the lower full-open flow rate of the secondary flow paths Q1 and Q2, and the dividing flow ratios a and b for paths Q1 and Q2 are both 1. The secondary flow path Q2 is fully opened, and a signal corresponding to the detected flow rate in the secondary flow path Q2 is given as a set signal for the secondary flow path Q1. The signal which corresponds to the detected flow rate in secondary flow path Q2 is multiplied by the ratio c, and the product is provided as a set signal for the secondary flow path Q3.

As will be apparent from FIG. 6, in the cases where a=c(=1)>b and b=c(=1)>a, the processes are the essentially the same as in the case where a=b(=1)>c.

In addition, in the case of a=b=c(=1), the secondary flow path Q3 is fully opened, and signals corresponding to the detected flow rate of the secondary flow path Q3 are given as set signals for the secondary flow paths Q1, Q2.

With a mass flow controller provided in each secondary flow path, and with the mass flow controllers controlled based on dividing flow ratios are set in CPU 111, wide ranges of divided flows may be obtained.

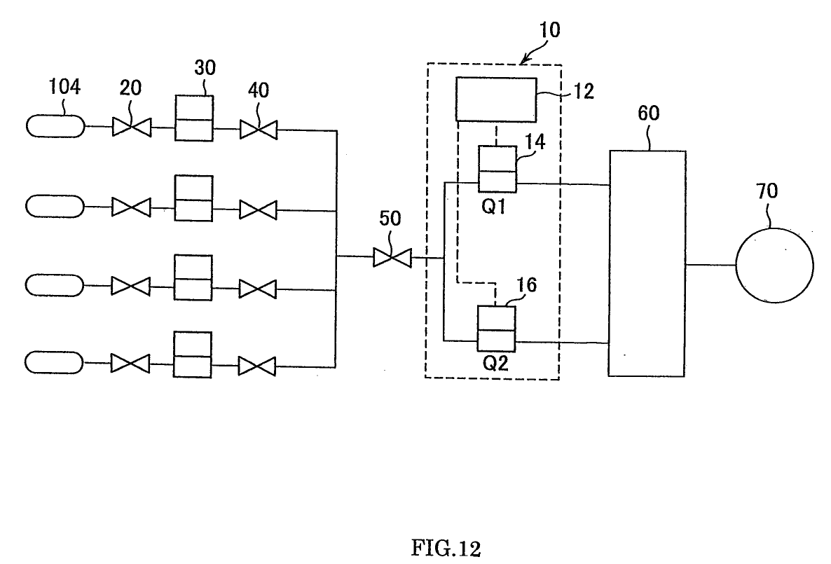

FIGS. 1 and 4 show systems for dividing gas flow for delivery to plural processing chambers each of which has a single inlet. The invention is also applicable to a system in which gas is delivered to a processing chamber through multiple inlets, as shown in FIG. 12.

It may be desirable to supply gas to a processing chamber through a plurality of inlets, for example, where conditions such as gas temperature and density differ at various locations within the processing chamber. Gas temperature and density may differ, for example, as a result of uneven flow of gas where the gas is supplied to a processing chamber through a single inlet and exhausted through a single gas outlet. Variations in gas temperature or density in the processing chamber can give rise to non-uniformity in the surface conditions of the wafer being treated.

In the system of FIG. 12, gas is divided by a flow dividing system 10 corresponding to the flow dividing system in FIG. 1, but the separate gas streams exiting the dividing system are delivered to a single processing chamber 60 through two inlets, and exhausted through a single outlet by a pump 70. By appropriately controlling the flow rates in the gas streams, the surface conditions of the wafer being treated can be kept uniform. Although in the embodiment shown in FIG. 12, the processing chamber 60 has two inlets, alternatively the processing chamber can be provided with three or more inlets, and associated with a dividing system, such as shown in FIG. 4, in which gas flow is divided into a corresponding number of flow paths.

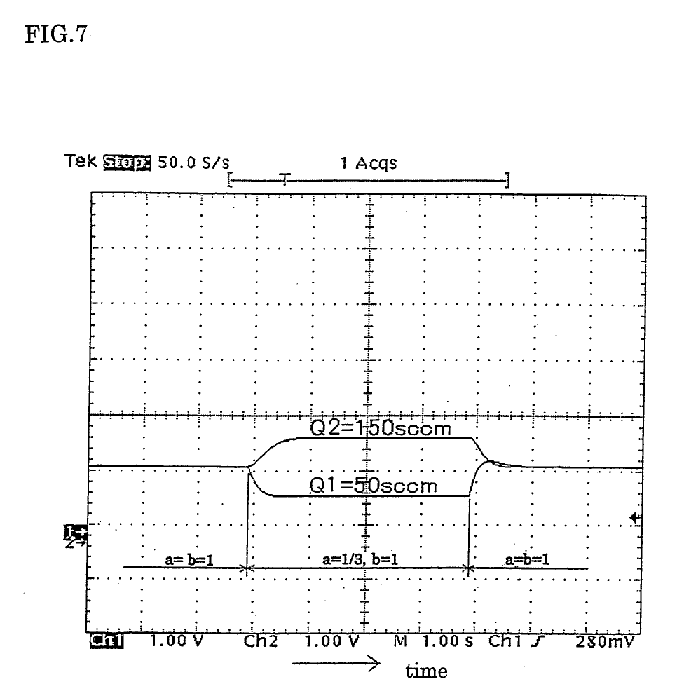

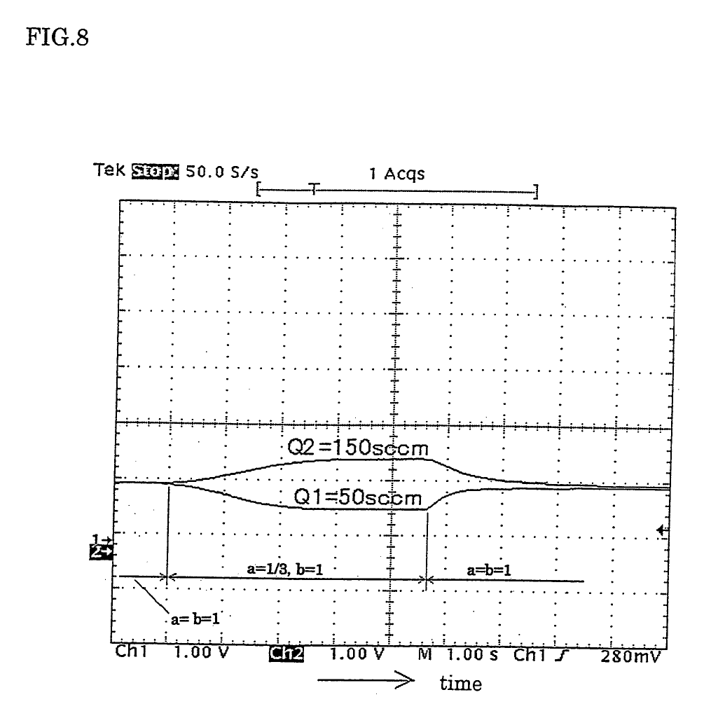

FIG. 7, shows a typical response of a system for dividing flow according to the invention, which uses a pressure-type mass flow controller, and in which gas is divided into two flow paths. This shows a response in the case where the gas flow rate is kept at 200 sccm, and the dividing flow ratios a and b, of the secondary flow paths Q1 and Q2, are changed from a=b=1 to a=⅓, b=1 by pressure sensing type mass flow controllers 14 and 16 in a flow dividing system 10 as shown in FIG. 1. On the other hand, FIG. 8 shows the response of a system for dividing flow which has the same structure as the system of FIG. 7 except in that a thermal-type mass flow meter and mass flow controller are used.

When FIG. 7 and FIG. 8 are compared, it will be seen that the response of the flow dividing system is by far superior in the case where a pressure sensing type mass flow controller is used than in the case where a thermal-type mass flow meter and mass flow controller are used.

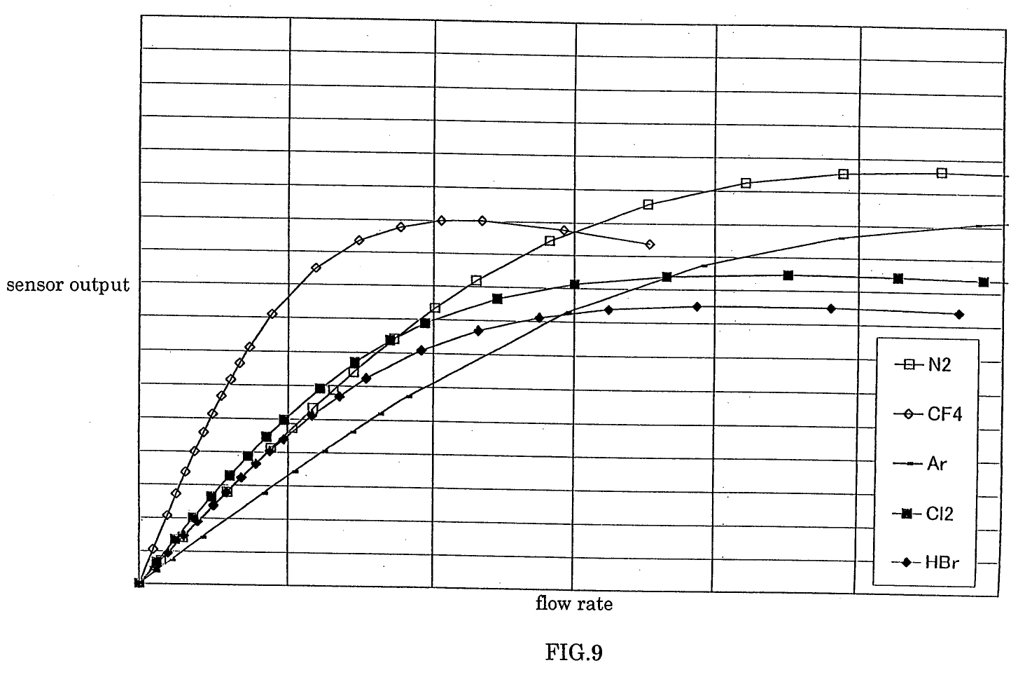

FIG. 9 is a characteristic diagram showing the relation between flow rate and output of a thermal-type mass flow meter of the kind which is conventionally used. Linear correction is applied electrically. However, linear correction may not work well when gases of greatly different characteristics are supplied. Therefore, linear correction is not appropriate for an apparatus wherein various kinds of gases are replaced and supplied. However, a system for dividing flow according to the invention may divide the flow of various kinds of gases accurately by using a pressure sensing type mass flow controller, which has superior linearity. A suitable pressure sensing type mass flow controller having excellent linearity is disclosed in Unexamined Japanese Patent Publication 268942/1998.

As described above, according to the invention, a mass flow controller is provided in each divided flow line, and a mass flow controller in one of the secondary flow paths is fully opened. The detected flow rate in the fully opened flow path is multiplied by a predetermined dividing flow ratio, which can be 1 or less, and the product is delivered as a set signal for another mass flow controller. The invention is suitable for use over a the range of divided flows, and may be adapted to any pattern for dividing flow. In addition, response may be improved and the throughput in the process may be increased by using a pressure sensing type mass flow controller. When a pressure sensing type mass flow controller is used, improved flow linearity may be obtained. Furthermore, various kinds of gases may be divided into a plurality of flow paths more accurately. Since a mass flow controller is provided in each of the secondary flow paths, any of the flow paths can be selected as the fully open gas flow path with reference to which the equal or lower flow rates in the other secondary flow paths are set.

What is claimed is:

1. A system for dividing gas flow, wherein a gas in a primary flow path is divided into a plurality of secondary flow paths, the flow rate of gas in each of said secondary flow paths being related to the flow rate in each other one of said secondary flow paths by a predetermined ratio, the system comprising:
a plurality of mass flow controllers, there being one of said mass flow controllers arranged to control flow in each said secondary flow path; and
a common controller connected to all of said mass flow controllers;
wherein one of said secondary flow paths is fully opened, the ratio of the flow rate of each other one of said secondary flow paths relative to the flow rate of said fully opened secondary flow path is set at a value of 1 or less, and said common controller delivers to the mass flow controller in each other one of said secondary flow paths, a set signal for controlling the flow therein, said set signal being obtained by multiplying the measured flow rate in said fully opened secondary flow path by the predetermined ratio for said one of said secondary flow paths.

2. A system for dividing gas flow as claimed in claim 1, wherein each said mass flow controller is a pressure sensing type mass flow controller.

3. A system for dividing gas flow as claimed in claim 1, wherein the secondary flow paths are connected to inlets of a single processing chamber.
